(19) United States
(12) Patent Application Publication
(10) Pub. No.: US 2012/0019494 A1
(43) Pub. Date: Jan. 26, 2012

(54) ALIGNMENT FACTOR FOR AMBIENT LIGHTING CALIBRATION

(75) Inventors: David W. Lum, Cupertino, CA (US); Ulrich Barnhoefer, Cupertino, CA (US); Nyok Khiam Lam, Singapore (SG); Paolo Sacchetto, Cupertino, CA (US)

(73) Assignee: APPLE INC., Cupertino, CA (US)

(21) Appl. No.: 13/007,413

(22) Filed: Jan. 14, 2011

Related U.S. Application Data
(60) Provisional application No. 61/367,845, filed on Jul. 26, 2010.

(51) Int. Cl. G09G 5/10

(52) U.S. Cl. 345/207

(57) ABSTRACT

A method, system, and apparatus that can be used to operate a display device in an energy efficient manner. The energy efficient display device can effectively and efficiently compensate for changes in ambient light incident at a display screen of the display device using an internal ambient light sensor to provide control signals to a backlight driver. Data from the ambient light sensor can be at least partially corrected to correspond more closely to a response of a Lambertian responsive light sensor

### CROSS REFERENCE TO RELATED APPLICATIONS

This U.S. patent application claims priority under 35 U.S.C. 119(e) to U.S. Provisional Application entitled “ALIGNMENT FACTOR FOR AMBIENT LIGHTING CALIBRATION” by Lum et al. filed Jul. 26, 2010 having Ser. No. 61/367,845 that is also incorporated by reference in its entirety for all purposes.

### FIELD OF THE DESCRIBED EMBODIMENTS

The described embodiments relate generally to display devices. In particular, apparatus, method and system for providing an ambient light calibration factor used in a transmissive display are described.

### DESCRIPTION OF THE RELATED ART

Solid state displays that use solid state elements such as liquid crystal, or LC, for presenting visual content have become ubiquitous. In a particular type of solid state display, a light source, referred to as a backlight, provides illumination that is used to form an image on a viewable display panel. For example, in those solid state displays that utilize liquid crystal image elements (referred to as a liquid crystal display, or LCD), the backlight can take the form of a discrete light source. In some cases, the backlight can take the form of a plurality of light emitting diodes, or LEDs, that can provide a substantially white light. The white light, in turn, that can be projected through an image forming layer having a plurality of image elements. The plurality of image elements can include a liquid crystal material that can be selectively rendered almost fully transparent to almost fully opaque based upon an image signal applied to control elements. When combined with color filters (usually three color filters are used representing the primary colors, red (R), blue (B), and green (G)), the plurality of image elements can form an array of pixels that can be used to create an image that can be viewed on a display panel that is typically covered by a protective layer formed of glass or plastic.

However, in order to provide a viewer with an acceptable (or in some cases, exceptional) viewing experience, the viewable image should appear bright and not washed out under all ambient light conditions. For example, in a viewing area that is brightly lit (naturally by sunlight or artificially using, for example, incandescent lighting), the image presented on the display panel can appear washed out due to the high ambient light level reducing the overall contrast between the displayed image and the surrounding area. Therefore, a number of displays attempt to maintain an acceptable viewing experience by using an ambient light sensor to detect an ambient light level. The ambient light level is then used to adjust the light output of the backlight. For example, the ambient light sensor compensates for ambient light by making the display bright enough for an acceptable viewing experience. Therefore, it is important for optimal viewing and power consumption that any change in ambient light level detected by the ambient light sensor be effectively compensated by modifying the amount of light provided by the backlight. This is particularly true for energy efficient display systems since it is the backlight that consumes a substantial amount of the power required to operate the display.

Therefore proper calibration of the ambient light sensor is crucial for a display to operate in an energy efficient manner.

In view of the foregoing, there is a need for providing an energy efficient display that provides a viewer with a desirable viewing experience under most if not all ambient light conditions.

### SUMMARY OF THE EMBODIMENTS

A method for adjusting an amount of light provided to a display image elements of a display device is described. The method can be carried out by a processor included in the display device having at least a memory and an ambient light sensor each being electrically coupled to the processor. In the described embodiment, the method can be performed by detecting ambient light at the light sensor, converting the detected ambient light into light sensor data, receiving the light sensor data at the processor, modifying the received light sensor data using an alignment factor by the processor, wherein the alignment factor at least partially compensates for a non-Lambertian angular response of the ambient light sensor, and modifying light output of the display device in accordance with the modified ambient light data.

A display device includes at least a plurality of image display elements, an ambient light sensor, a memory device, an adjustable illumination source arranged to illuminate at least some of the plurality of image display elements, the illuminated image display elements used to present an image by the display device, and a processor coupled to the ambient light sensor and the memory device, the processor arranged to execute instructions for providing an illumination adjustment signal to the adjustable illumination source based upon a detected ambient light level by receiving light sensor data, the light sensor data corresponding to ambient light detected at the ambient light sensor, modifying the received light sensor data using an alignment factor AF. The alignment factor AF at least partially compensates for a non-Lambertian angular response of the ambient light sensor and using the alignment factor AF to generate the illumination adjustment signal.

Non-transitory computer readable medium executable by a process in a display device, the display device having at least a memory and an ambient light sensor each being electrically coupled to the processor is described. The non-transitory computer readable medium includes at least computer code for detecting ambient light at the light sensor, computer code for converting the detected ambient light into light sensor data, computer code for receiving the light sensor data at the processor, computer code for modifying the received light sensor data using an alignment factor AF by the processor. The alignment factor AF at least partially compensates for a non-Lambertian angular response of the ambient light sensor. The computer readable medium also includes computer code for modifying light output of the display device in accordance with the modified ambient light data.

Other apparatuses, methods, features and advantages of the described embodiments will be or will become apparent to one with skill in the art upon examination of the following figures and detailed description. It is intended that all such additional apparatuses, methods, features and advantages be included within this description be within the scope of and protected by the accompanying claims.

### BRIEF DESCRIPTION OF THE DRAWINGS

The embodiments will be readily understood by the following detailed description in conjunction with the accompanying drawings, wherein like reference numerals designate like structural elements, and in which:

FIG. 1 graphically illustrates the data presented in Table 1 showing representative Lambertian angular response curve and representative non-Lambertian angular response curve typical of a less costly light sensor.

FIG. 2 shows representative display undergoing calibration where calibration system

FIG. 3 shows representative calibration system in accordance with the described embodiments.

FIG. 4 shows a calibration factor CF stored in a display device in accordance with the described embodiments.

FIG. 5 shows a flowchart detailing a process for generating an ambient light calibration factor in accordance with the described embodiments.

FIG. 6 shows a flowchart describing a process for storing an ambient light calibration factor CF in accordance with the described embodiments.

FIG. 7 shows a flowchart describing a process for utilizing an ambient light calibration factor CF in a display system in accordance with the described embodiments.

FIG. 8 shows a flowchart describing a process for validating a calibration coefficient in accordance with an embodiment of the invention.

FIGS. 9-11 show flowcharts detailing a process for providing an alignment calibration factor AF in accordance with the described embodiments.

FIG. 12 is an exploded perspective view of liquid crystal display (LCD) in accordance with an embodiment of the invention.

FIG. 13 is a cross-sectional view showing one side of the LCD shown in FIG. 12 in an assembly state.

### DESCRIBED EMBODIMENTS

In the following paper, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

This paper discusses a method, system, and apparatus that can be used to operate a display device in an energy efficient manner. In one embodiment, an alignment calibration factor AF can be used to compensate for an ambient light sensor having a non-Lambertian angular response. Typically, display systems utilize low cost light sensing systems to detect ambient light. These low cost light sensing systems generally do not have a well defined angular response. However, in order to simulate an ambient lighting environment in a cost and space effective manner, high cost light sensing systems that do have a well defined angular response (referred to as a Lambertian response) are used. A Lambertian type light sensing system has a well defined angular response having shape similar to a cosine curve with a maximum value at about 0=0° and a minimum value at about where θ=90° where θ is the angle between the light receiving portion of the sensor and the light source. The advantage to using a Lambertian type light sensing system is that the transition between the maximum and minimum values is predictable and well defined.

Using a Lambertian type light sensing system lends itself to simulating an ambient lighting environment in a space and cost effective manner. For example, in order to capture as much diffuse light as possible in a small space using a limited number of light sources, a Lambertian type light sensing system is oriented in such a way that the angle between the light sensor of the light sensing system and the light sources is about 0=90°. In this way, by capturing as much diffused light as possible, the ambient lighting environment can be simulated quickly and in a cost effective manner. However, in most displays, the ambient light sensing system is usually oriented in such a way that the angle between the light sensor and the light source is θ=0° (facing out from the display screen). Since the typical light sensor used in most displays is non-Lambertian, it is difficult to correlate the light readings taken during the simulation (using the Lambertian light sensor) to the light readings taken during operation of the display using the non-Lambertian light sensor. Therefore, the described embodiments teach an alignment factor (AF) can be used to provide a control signal for modifying an operation of a backlight driver unit to compensate for changes in an ambient light environment.

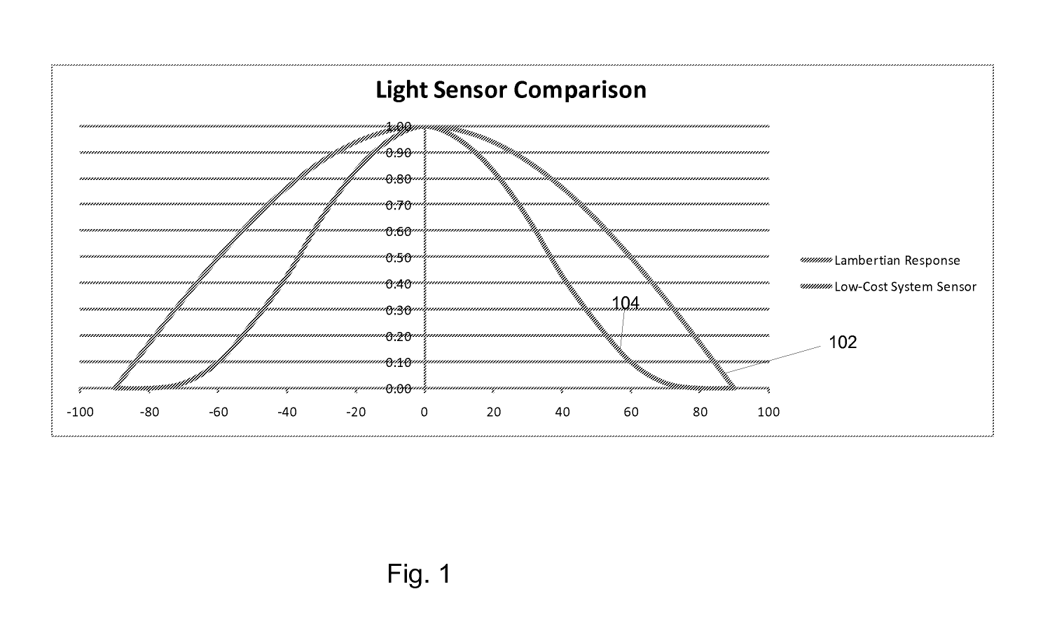

These and other embodiments are discussed below with reference to FIGS. 1-13. However, those skilled in the art will readily appreciate that the detailed description given herein with respect to these figures is for explanatory purposes only and should not be construed as limiting.

Table 1 shows responses of a Lambertian type light sensor and a non-Lambertian type sensor in accordance with the described embodiments.

TABLE 1

| | | Non- |
|---|---|---|
| | Lambertian | Lambertian |
| Angle | Response | Response |
| −90 | 0.00 | 0.00 |
| −80 | 0.17 | 0.00 |
| −70 | 0.34 | 0.02 |
| −60 | 0.50 | 0.10 |
| −50 | 0.64 | 0.25 |
| −40 | 0.77 | 0.43 |
| −30 | 0.87 | 0.65 |
| −20 | 0.94 | 0.83 |
| −10 | 0.98 | 0.95 |
| 0 | 1.00 | 1.00 |
| 10 | 0.98 | 0.95 |
| 20 | 0.94 | 0.83 |
| 30 | 0.87 | 0.65 |
| 40 | 0.77 | 0.43 |
| 50 | 0.64 | 0.25 |
| 60 | 0.50 | 0.10 |
| 70 | 0.34 | 0.02 |
| 80 | 0.17 | 0.00 |
| 90 | 0.00 | 0.00 |

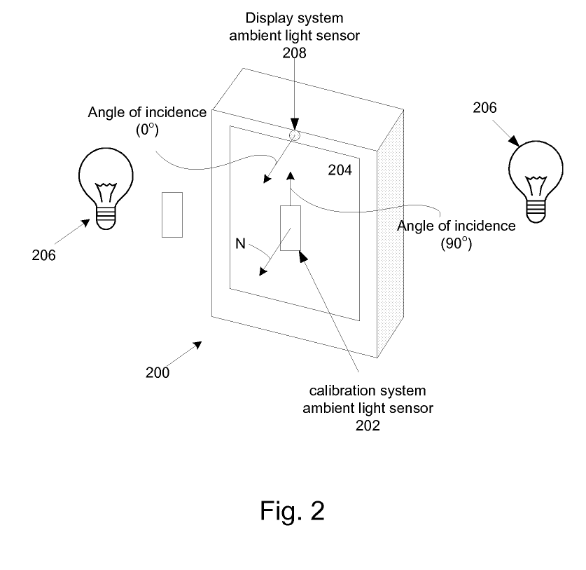

FIG. 1 graphically illustrates the data presented in Table 1 showing representative Lambertian angular response curve 102 and representative non-Lambertian angular response curve 104 typical of a less costly light sensor. During calibration and characterization of the display device, external ambient light sensors that exhibit a Lambertian (or essentially Lambertian) angular response can be used to detect an ambient light level. For example, FIG. 2 shows representative display 200 undergoing calibration where calibration system ambient light sensor 202 having a Lambertian response can be oriented to have an angle of incidence of about 90° relative to normal N of display screen 204. In this orientation, sensor 202 can capture an optimal amount of diffuse ambient light provided by light sources 206. However, display system ambient light sensor 208 is one that generally is not expected to exhibit the Lambertian angular response curve 102 but more likely to have an angular response more like that of non-Lambertian angular response curve 104. In the described embodiment, alignment calibration factor AF can be used to account for the differences in angular response between the calibration data provided by calibration system ambient light sensor 202 and display system light sensor 208. In this way, alignment calibration factor AF can be used to modify the operation of the backlight driver unit separately or in combination with calibration factor CF.

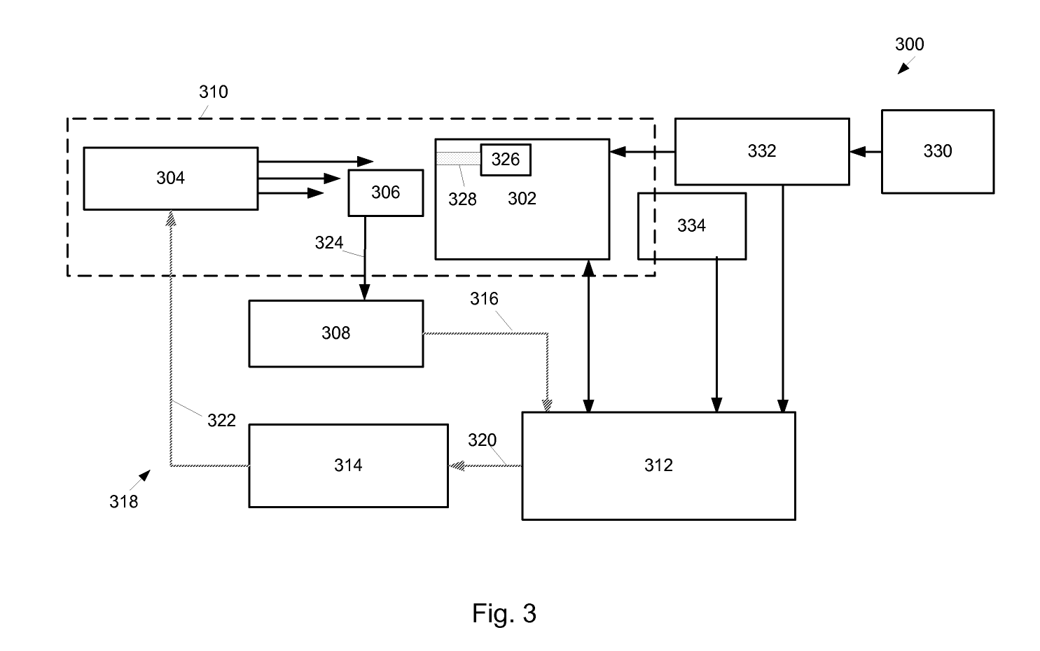

FIG. 3 shows representative calibration system 300 in accordance with the described embodiments. Calibration system 300 can be used to determine validated calibration factors (CF) and alignment calibration factor AF each of which can be used to modify a control signal provided to a backlight provider. The control signal can be used to control an amount of light output from an illumination source such as a backlight. The modification of light provided by the backlight can be in accordance with a change in an ambient light level detected by an ambient light detector. Calibration system 300 can be used in a laboratory environment or in a manufacturing environment to accurately determine consistent and validated calibration factors for a particular display system under a variety of ambient light conditions. Calibration system 300 can include at least system under test (SUT) 302, light source 304 and light sensor 306 electrically connected to and part of light meter 308. SUT 302 can take the form of a solid state display along the lines of a liquid crystal display, or LCD. Light source 304 can take the form of an incandescent light, a CCFL or a plurality of light emitting diodes, or LEDs. Light sensor 306 can include a photo detector unit and associated circuitry. Enclosure 310 can optically isolate SUT 302, light source 304 and light sensor 306 from the external environment. In this way, the calibration process can be unaffected by any extraneous light not originating from light source 304. Enclosure 310 can take the form of a shroud formed of opaque material such as black cloth or other appropriate materials.

Light meter 308 can receive electrical signals from light sensor 306 indicative of an amount of light detected by a photo-detector included in light sensor 306. In the described embodiment, light sensor 306 can be placed in close proximity to SUT 302 in order to accurately simulate the amount and intensity of light from light source 304 that reaches SUT 302. By placing light sensor 306 in close proximity to SUT 302, any attenuation of light from light source 304 can be taken into account providing a more accurate calibration of light source 304 and ultimately calibration factor CF for SUT 302. For example, when light source 304 provides light having luminance level L_{source}, then any attenuation can result in light received at SUT 302 having a reduced luminance value L_{SUT} that is less than L_{source}. Light sensor 306 can be placed in close proximity to SUT 302 having luminance value Lₛₑₙₛₑ that is essentially the same as that of the light received at SUT 302, namely Lₛₑₙₛₑ is proportional to L_{SUT}.

Light meter 308 can be electrically connected to process computer 312. Process computer 312 can be a standalone unit or be incorporated into a separate calibration unit either of which can be coupled directly to a data port of SUT 302. In any case, process computer 312 can provide control signals to programmable power supply 314 in response to input signal 316 received from light meter 308. Input signal 316 can, in turn, be directly related to the luminance Lₛₑₙₛₑ of light from light source 304 received at light sensor 306. In this way, control loop 318 can be used by process computer 312 to calibrate light source 304.

In one embodiment, light source 304 can be calibrated to simulate a user's expected ambient light level at SUT 302. For example, light source 304 can be calibrated to provide an ambient light level having a luminance value of about 300 lux (lx) where 1 lx is equal to 1 lumen (lm) per square meter (m²).

In one embodiment, control loop 318 can operate as follows. Based upon a target luminance value provided to process computer 312, process computer 312 can provide control signal 320 to programmable power supply 314. Programmable power supply 314 can respond to control signal 320 by sending power signal 322 to light source 304. Power signal 322 can cause light source 304 to either increase or decrease an amount of light detected at light sensor 306. Light sensor 306, in turn, generate signal 324 that can be passed to light meter 308. Light meter 308 can pass signal 316 indicative of the amount of light from light source 304 detected at light sensor 306. Process computer 312 can evaluate information provided by signal 316 in order to determine if light source 304 is providing light within an acceptable range of a target luminance value. Based upon the evaluation, process computer 312 determines that light source 304 is providing light within the acceptable range of the target luminance value, then the control loop ends, otherwise, process computer 312 updates control signal 320 in accordance with the evaluation of the light output of light source 304.

SUT 302 can include internal light sensor 326. Light from light source 304 reaching SUT 302 as calibrated ambient light L_{SUT} can reach internal light sensor 326 by following optical path 328. As described above, optical path 328 can present a number of elements each of which can affect the detection of ambient light L_{SUT} by internal light sensor 326. Since light source 304 has been calibrated to provide light in the acceptable range of the target luminance value, the luminance of ambient light L_{SUT} can be provided to SUT 302 by process computer 312 as a corrected light meter reading (LC≈L_{SUT}). In this way, the light level (LS) detected by internal sensor 326 can be used to determine calibration factor CF according to equation (1):

$$CF = \frac{LC}{LS} \qquad Eq ( 1 )$$

In order to validate calibration factor CF, SUT 302 can report calibration factor CF to process computer 312 for validation. By validating calibration factor CF, process computer 312 can verify that calibration factor CF is within an allowable range of calibration factors. This allowable range of calibration factors can be based upon, for example, tolerances of the various optical elements included in the optical path. Such elements can include, for example, light pipes, light sensor angle, the light sensor, and so on as described above.

In the described embodiment, process computer 312 can validate calibration factor CF as follows. Process computer 312 can determine power level P provided by power source 330 by reading power meter 332 at, for example, a user's typical ambient light level L_{typical} as detected by screen luminance meter 334. Power level P can then be compared to design limits based upon energy standards (such as those provided by the Environmental Protection Agency, or EPA, as determined by the EnergyStar standard) and any power consumption tolerance of SUT 302. In some cases, process computer 312 can also verify that light emitted by the display of SUT 302 is within established design limits.

As part of the validation of the calibration factor, process computer 312 can determine power level P_{L} corresponding to a condition of low ambient light level and power level P_{H} corresponding to a condition of high ambient light level. Process computer 312 use the determined values of P_{L} and P_{H} to calculate average weighted power Pavg based upon equation (2)

P_{avg}=WH×PH+WL×PL (2)

where:
Pavg is weighted average power;
WH is brighter (higher) lighting condition weight factor;
PH is brighter (higher) lighting condition power level;
WL is darker (lower) lighting condition weight factor; and
PL is darker (lower) lighting condition power level.

In the described embodiment, weighting factor WH is typically greater than weighting factor WL in order to provide a more conservative (power wise) estimate of the power consumption of SUT302. For example, weighting factor WH can be on the order of 0.8 whereas weighting factor WL can be on the order of 0.2.

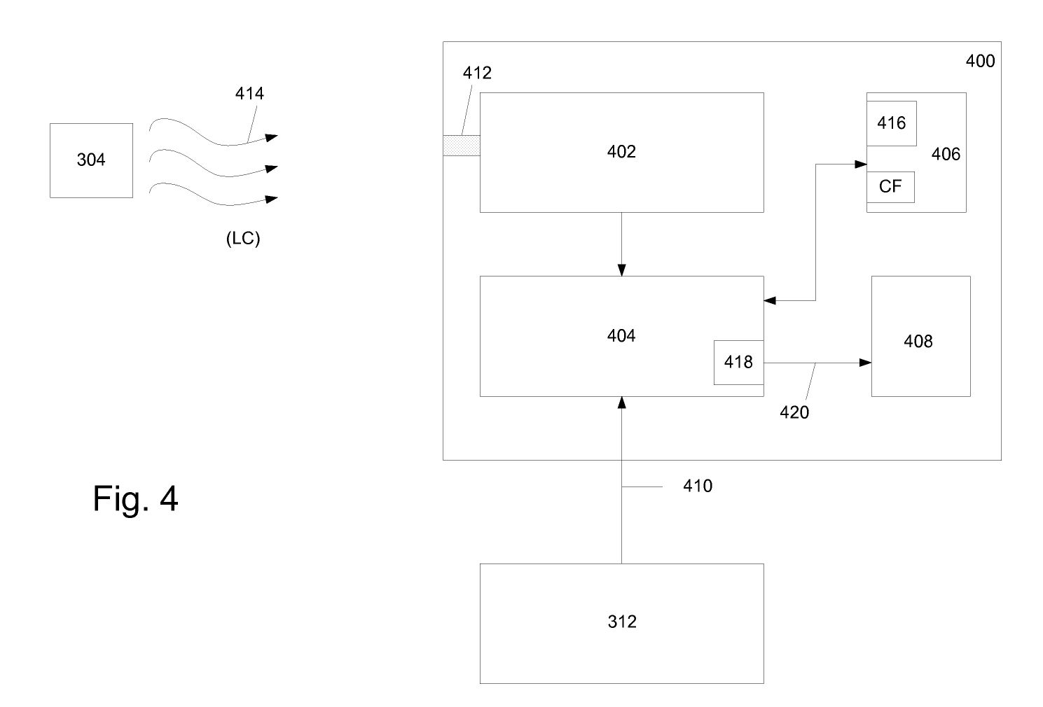

As further shown in FIG. 4 calibration factor CF can be stored in SUT 302 in the form of display device 400. Display device 400 can include light sensor 402, system processor 404, and memory device 406 that can take the form of non-volatile memory such as EEPROM. Display device 406 can also include backlight driver 408 configured to provide control signals to a backlight unit (not shown) that provides illumination used to provide a displayable image on a display panel. Calibration factor CF can be stored in display system 400 in one embodiment as follows. Process computer 312 can be connected to system 400 by way of an input/output data port such as a USB data port. Process computer 312 can cause display device 400 to enter a calibration mode by process computer 312 sending trigger signal 410 system processor 404.

In one embodiment, trigger signal 410 can include information such as corrected light meter reading LC. In calibration mode, system processor 404 can sample light sensor 402 for an indication a luminance value of light received through optical path 412 corresponding to ambient light 414 provided by light source 304. System processor 404 can then calculate calibration factor CF based upon the sampled light reading LS and light meter reading LC according to equation (1). Once calculated, calibration factor CF can be stored in memory device 406. Once calibration factor CF is stored in memory device 406, system processor 404 can cause display device 400 to exit the calibration mode. In one embodiment, display device 400 exits the calibration mode after system processor 404 has reported calibration factor CF to process computer 312.

Once calibration factor CF has been stored in memory device 406 and display device 400 is no longer in calibration mode, system processor 404 can retrieve calibration factor CF from memory device 406 as well as any user settings 416 (such as a most recent brightness) from memory device 406. During normal operation of display device 400, system processor 404 can sample light received at light sensor 402 and determine calibrated ambient light level LA as equation 3:

LA=CF×LS eq. (3)

System 400 can apply calibrated ambient light level LA and any user settings to ambient light control function 418 executed by system processor 404. Ambient light control function 418 can issue command 420 to backlight driver 408 that can respond by, for example, changing a backlight duty cycle and/or a backlight phase.

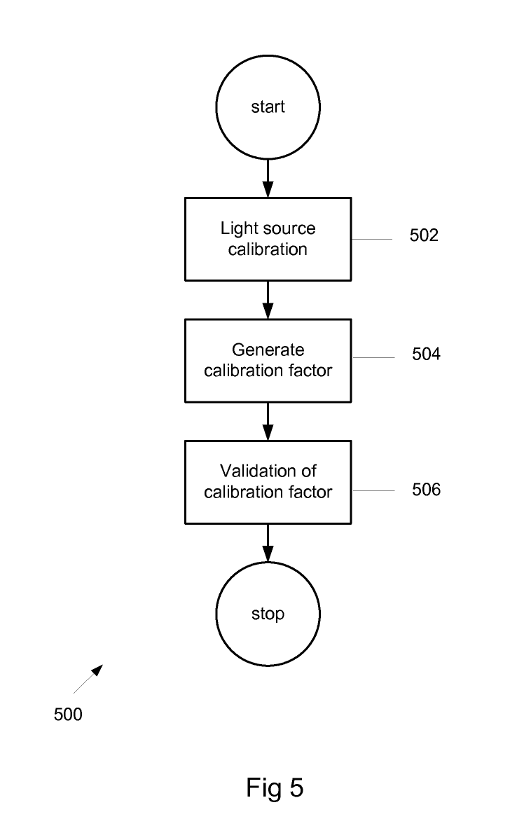

FIG. 5 shows a flowchart detailing process 500 for generating a calibration factor for modifying a control signal used by a backlight driver to compensate for an ambient light condition in accordance with the described embodiments. Process 500 can begin at 502 by calibrating a light source. The light source can be calibrated to a target luminance value. The target luminance value can correspond to an expected ambient light condition experienced by a display device. Next at 504, a calibration factor CF is determined based upon, in part, the light provided by the calibrated light source. An ambient light sensor internal to a display device detects the light provided by the calibrated light source having a known target luminance. The luminance value of the light detected by the internal ambient light sensor is then compared to the light provided by the calibrated light source at the target luminance. The calibration factor CF is that ratio of the detected luminance value and the target luminance value. The calibration factor CF can be used to compensate for variations caused by elements in an optical path that the light from the light source must travel to reach the internal ambient light detector. Next, at 506, the calibration factor CF is validated. By validation, it is meant that the energy usage and screen luminance values are evaluated for compliance to both system design standard and energy efficiency standard.

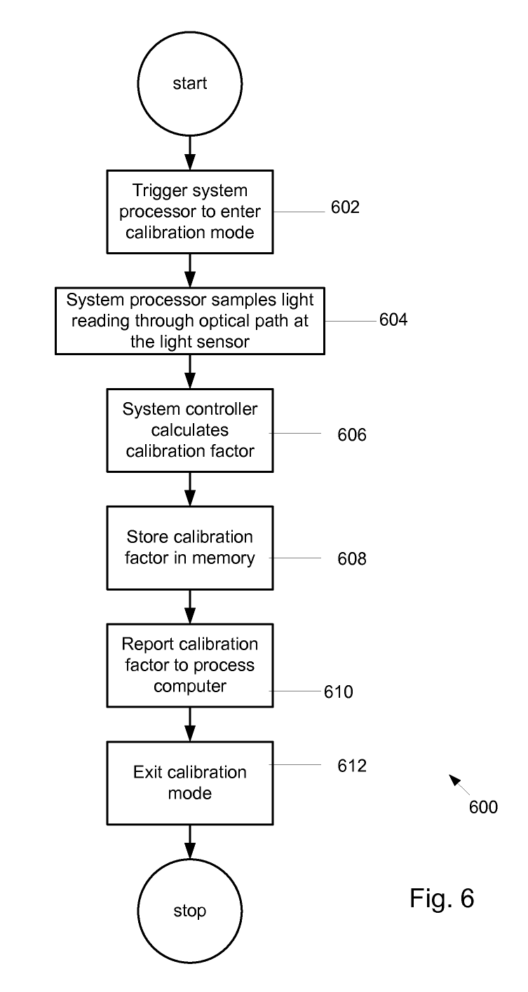

FIG. 6 shows a flowchart describing process 600 for storing an ambient light calibration factor CF in accordance with the described embodiments. Process 600 can begin at 602 by triggering a system processor to enter a calibration mode. In the calibration mode, the system processor can receive data from an internal light sensor at 604. The data received from the internal light sensor can correspond to ambient light provided by a calibrated light source. At 606, the system processor can then calculate a calibration factor CF based upon the data received from the internal light sensor and data received from an external circuit such as a process computer. The data received from the process computer can include a corrected light meter reading. At 608, the calibration factor CF can be stored in a memory device and reported to the process computer at 610 at which point, the system processor can exit the calibration mode at 612.

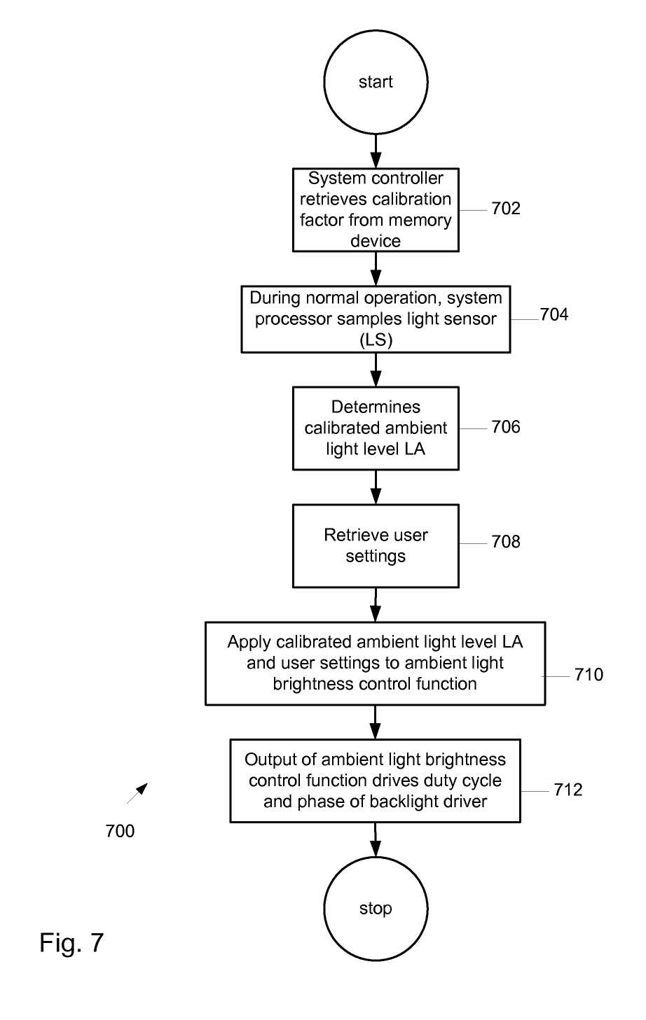

FIG. 7 shows a flowchart describing process 700 for utilizing an ambient light calibration factor CF in a display system in accordance with the described embodiments. Process 700 can begin at 702 by the system controller retrieving the calibration factor CF from the memory device. At 704, during normal operation, the system processor can receive data from the internal ambient light sensor. At 706, a calibrated ambient light level is determined based upon the calibration factor CF and the data received from the internal sensor. At 708, the calibrated ambient light level and any user settings are retrieved from the memory device. They are applied to an ambient light brightness control function at 710. In one embodiment, the ambient light brightness control function can be executed by the system processor. At 712, the ambient light brightness control function can modify the output of a backlight driver. In one embodiment, a duty cycle and brightness can be modified.

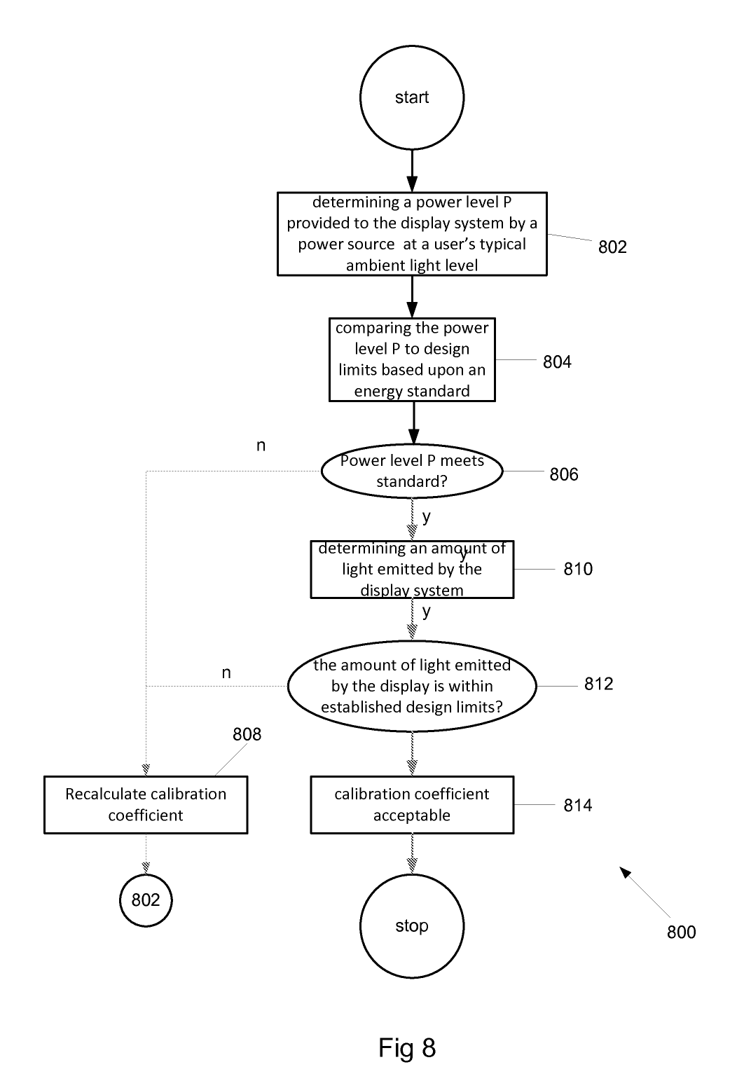

FIG. 8 shows a flowchart detailing process 800 for validating a calibration coefficient in accordance with the described embodiments. Process 800 can being at 802 by determining a power level P provided to a display system by a power source at a user's typical ambient light level. Next at 804, the power level P is compared to design limit power levels based in part upon an energy standard. For example, the energy standard includes power limits defining what is considered to be an energy efficient display. At 806, if the power level P does not meet the standard, then at 808 the calibration factor is re-calculated and control is passed back to 802. On the other hand, if the power level does meet the standard, then at 810 a determination of an amount of light emitted by the display is determined. At 812, the amount of light emitted by the display is then compared to design limits for the display. If the light emitted by the display does not meet the design limits, then at 808, the calibration factor is recalculated and control is passed back to 802, otherwise, the calibration coefficient is acceptable at 814.

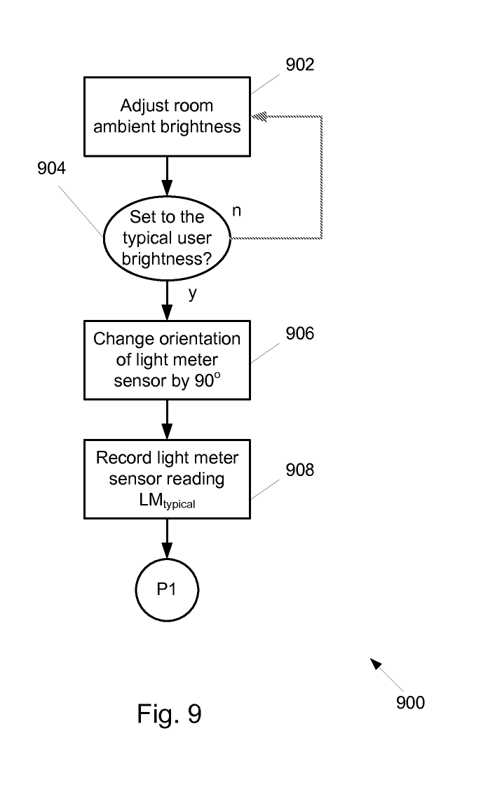

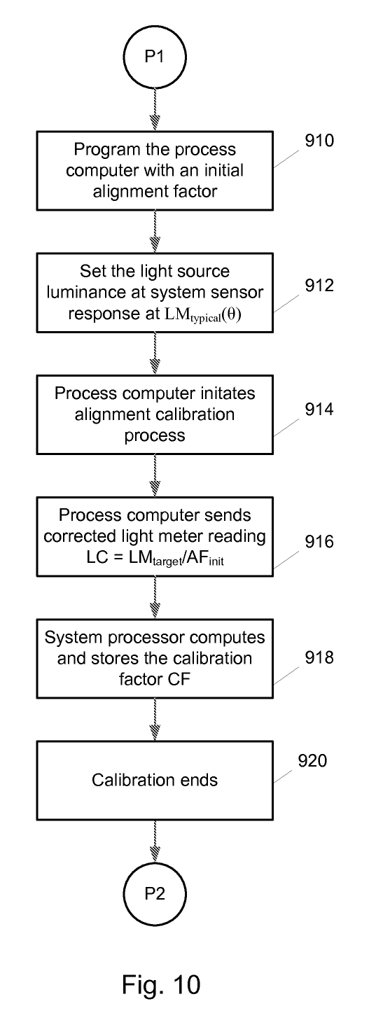

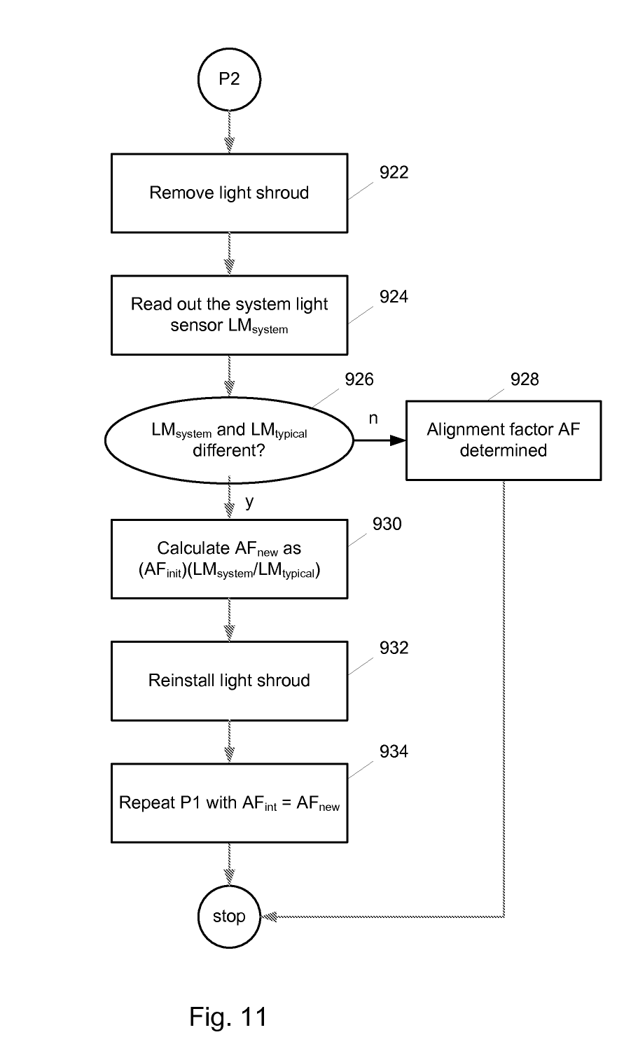

FIGS. 9-11 show flowcharts detailing process 900 for providing an alignment calibration factor AF in accordance with the described embodiments. Process 900 can begin at FIG. 9 at step 902 by adjusting room ambient brightness until it is determined at 904 that the room ambient brightness is set to the typical user brightness. Next at 906, the orientation of the light meter sensor is changed by 90°. For example, the orientation of the light meter can change from 90° to 0°. At 908, a light meter sensor reading is recorded. Process 900 then proceeds to flowchart shown in FIG. 10 starting at step 910 where an initial alignment calibration factor AFᵢₙₜ is stored in the process computer. At 912, the light source luminance is set to a luminance value of the light sensing system response LMᵤₛₑᵣ (θ). In the described embodiment, pre-determined angle θ can be experimentally determined. For example, pre-determined angle θ can be 60° having a value from FIG. 1 of about 0.10. In this example, if LMᵤₛₑᵣ₎(0° is 300 lux, then the light source luminance is set to about 30 lux (300×0.10). At 914, the process computer initiates the alignment calibration procedure. At 916, the process computer sends a corrected light meter reading (LC=LM_{target}/AFᵢₙᵢₜ) to the system processor. At 918, the system processor computes and stores the calibration factor CF based upon the corrected light meter reading after which the calibration ends at 920. The process 900 is further described by the flowchart shown in FIG. 11 starting at step 922 where the light shroud is removed. At 924, data from the system light sensor is read out as LM_{system}. At 926, a determination is made if LM_{system} and LM_{typical} are different. If LM_{system} and LM_{typical} are not different, then the alignment factor AF is determined at 928, otherwise at 930, AF_{new} is calculated as AFᵢₙᵢₜ(LM_{system}/LM_{typical}). The light shroud is re-installed at 932 and at 934 steps 910 through 920 are repeated.

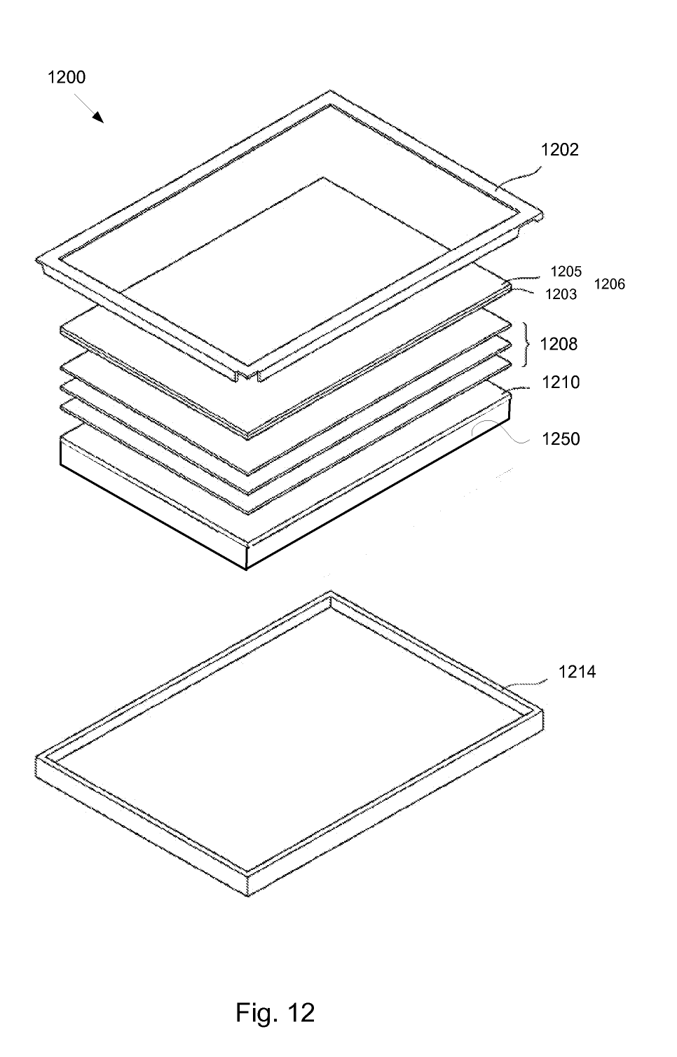

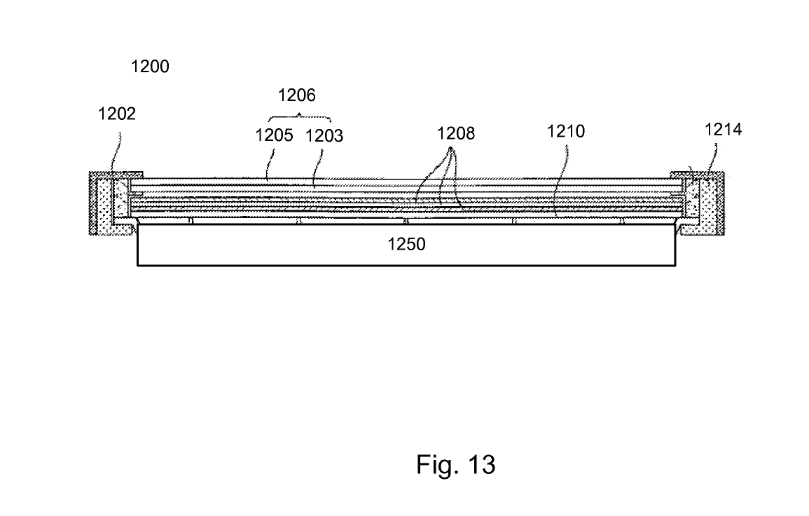

FIG. 12 is an exploded perspective view of liquid crystal display (LCD) 1200 in accordance with an embodiment of the invention. FIG. 13 is a cross-sectional view showing one side of LCD 1200 shown in FIG. 12 in an assembly state. Referring to FIGS. 12 and 13, LCD 1200 includes support main 1214, backlight unit 1250, and liquid crystal display panel 1206 stacked within the support main 1214, and top casing 1202 for surrounding the edges of liquid crystal display (LCD) panel 1206 and lateral portions of the support main 1214. LCD panel 1206 includes liquid crystal intervened between front substrate 1205 and rear substrate 1203, and spacers for maintaining a gap between the front substrate 1205 and rear substrate 1203. A color filter and a black matrix are formed in the front substrate 1205 of the LCD panel 1206. Signal lines, such as data lines and gate lines, are formed in the rear substrate 1203 of LCD panel 1206. A thin film transistor (hereinafter referred to as a “TFT”) is formed at crossings of the data lines and the gate lines. The TFT switches a data signal to transmit the data signal from the data line to a liquid crystal cell, in response to a scan signal gate pulse transmitted from the gate line. A pixel electrode is formed in a pixel area between the data line and the gate line. Further, pad regions to which the data lines and the gate lines are respectively coupled are formed in one side of rear substrate 1203. A driver integrated circuit (not shown) for applying a driving signal to the TFT is mounted is attached to each pad region. The data signal, transmitted from the driver integrated circuit, is sent to the data lines and also supplies a scan signal to the gate lines. An upper polarization sheet is attached to front substrate 1205 of LCD panel 1206, and a lower polarization sheet is attached to rear substrate 1203 of rear substrate 1203.

Backlight unit 1250 includes plurality of light sources for illuminating light to LCD panel 1206. The light sources can be LED devices. The duty ratio of the output signal of the inverter is Tₒₙ×100/(Tₒₙ+T_{off}), where ‘Tₒₙ’ denotes a turn-on period of the light source and ‘T_{off}’ denotes a turn-off period of the light source. The duty ratio of the output signal determines the luminance of the light source.

The plurality of optical sheets 1208 stacked over the diffusion sheet 1210 redirects light incident from the diffusion sheet 1210 to be incident perpendicular to the liquid crystal display panel 1206, thus improving optical efficiency. To this end, the optical sheets 1208 include two sheets of prism sheets and two sheets of spreading sheets. The two sheets of prism sheets stand a travel angle of spreading light, emitted from the diffusion sheet 1210, in a direction vertical to the liquid crystal display panel 1206. The two sheets of spreading sheets spread the vertically incident light again. The top casing 1202 is formed in a rectangular belt having a plan portion and a lateral portion, which are curved at a right angle to each other and surrounds the corners of the LCD panel 1206 and the sides of the support main 1214.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

While the embodiments have been described in terms of several particular embodiments, there are alterations, permutations, and equivalents, which fall within the scope of these general concepts. It should also be noted that there are many alternative ways of implementing the methods and apparatuses of the present embodiments. For example, although an extrusion process is preferred method of manufacturing the integral tube, it should be noted that this is not a limitation and that other manufacturing methods can be used (e.g., injection molding). It is therefore intended that the following appended claims be interpreted as including all such alterations, permutations, and equivalents as fall within the true spirit and scope of the described embodiments.

1. A method performed by a processor in a display device having at least a memory device and an ambient light sensor each being electrically coupled to the processor, the method comprising:
detecting ambient light at the light sensor;
converting the detected ambient light into light sensor data;
receiving the light sensor data at the processor;
modifying the received light sensor data using at least a calibration factor by the processor, wherein the calibration factor at least partially compensates for a non-Lambertian angular response of the ambient light sensor; and
modifying light output of the display device in accordance with the modified ambient light data.

2. The method as recited in claim 1, further comprising:
generating the alignment factor; and
storing the alignment factor in the process computer's code.

3. The method as recited in claim 2, wherein the generating the alignment factor comprises:
during an ambient light sensor calibration operation,
(a) providing an ambient light sensor calibration setup in a calibration enclosure, the ambient light sensor calibration setup including at least a Lambertian responsive light sensor, a light source arranged to provide an adjustable light level and an adjustable orientation in relation to the ambient light sensor;
(b) adjusting a brightness level of the ambient light of the calibration enclosure;
(c) changing an orientation of the ambient light sensor relative to the light source;
(c) reading data from a light meter in accordance with light detected by the light sensor;
(d) setting a target luminance of the light source to a pre-determined value;
(e) forwarding a corrected light meter reading to a processor;
(f) computing calibration factor CF by the system processor based upon the corrected light meter reading and an initial alignment factor AFᵢₙₜ; and
(g) storing the calibration factor CF.

4. The method as recited in claim 3, wherein the enclosure ambient brightness level is a typical user brightness level LM_{typical}.

5. The method as recited in claim 4, wherein the pre-determined value of the target luminance is based upon a Lambertian response and the user brightness level LMᵤₛₑᵣ.

6. The method as recited in claim 5, wherein the corrected light meter reading is based upon a target brightness level LM_{target} and the initial alignment factor AFᵢₙₜ.

7. The method as recited in claim 6, further comprising:
reading data LM_{system} from the light sensor;
if the data LM_{system} is different from user brightness level LM_{typical}, then calculating a updated alignment factor AF_{new}, otherwise,
storing the alignment factor AF in the process computer's code.

8. The method as recited in claim 3, wherein the repeating (b) through (g) until the data LM_{system} is about equal to user brightness level LM_{typical}.

9. A display device, comprising:
a plurality of image display elements;
an ambient light sensor;
a memory device;
an adjustable illumination source, the adjustable illumination source arranged to illuminate at least some of the plurality of image display elements, the illuminated image display elements used to present an image by the display device; and
a processor coupled to the ambient light sensor and the memory device, the processor arranged to execute instructions for providing an illumination adjustment signal to the adjustable illumination source based upon a detected ambient light level by receiving light sensor data, the light sensor data corresponding to ambient light detected at the ambient light sensor, modifying the received light sensor data using at least calibration factor CF, wherein the calibration factor CF at least partially compensates for a non-Lambertian angular response of the ambient light sensor and using the alignment factor AF to generate the illumination adjustment signal.

10. The display device as recited in claim 9, wherein the calibration factor at least partially compensates for a non-Lambertian angular response of the ambient light sensor to the ambient light.

11. The display device as recited in claim 10, wherein the calibration factor is generated during an ambient light sensor calibration operation by
(a) providing an ambient light sensor calibration setup in a calibration enclosure, the ambient light sensor calibration setup including at least a Lambertian responsive light sensor, a light source arranged to provide an adjustable light level and an adjustable orientation in relation to the ambient light sensor;
(b) adjusting a brightness level of the ambient light of the calibration enclosure;
(c) reading data from a light meter in accordance with light detected by the light sensor;
(d) setting a target luminance of the light source to a pre-determined value;
(e) forwarding a corrected light meter reading to a processor;
(f) computing a calibration factor CF by the processor based upon the corrected light meter reading and alignment factor AF; and
(g) storing the alignment factor AF.

12. The display device as recited in claim 9, wherein the adjustable illumination source is a backlight.

13. The display device as recited in claim 12, wherein the backlight is comprised of a plurality of light emitting diodes (LEDs).

14. The display device as recited in claim 13, wherein the backlight is provided power by a backlight power supply having an adjustable duty cycle.

15. The display device as recited in claim 14, wherein the duty cycle is adjusted in response to the illumination adjustment signal.

16. Non-transitory computer readable medium executable by a process in a display device, the display device having at least a memory and an ambient light sensor each being electrically coupled to the processor, the comprising:
computer code for detecting ambient light at the light sensor;
computer code for converting the detected ambient light into light sensor data;
computer code for receiving the light sensor data at the processor;
computer code for modifying the received light sensor data using at least a calibration factor CF by the processor, wherein the calibration factor CF at least partially compensates for a non-Lambertian angular response of the ambient light sensor; and
computer code for modifying light output of the display device in accordance with the modified ambient light data.

17. The computer readable medium as recited in claim 16, further comprising:
computer code for receiving the calibration factor CF and
computer code for storing the calibration factor in the memory device.

18. The computer readable medium as recited in claim 16, wherein the calibration factor at least partially compensates for a non-Lambertian angular response of the ambient light sensor to the ambient light.

19. The computer readable medium as recited in claim 18, further comprising:
computer code for generating an illumination source control signal in accordance with the modified ambient light data, the illumination source illuminating at least some of a plurality of image display elements to provide an image by the display device.

20. The computer readable medium as recited in claim 19, further comprising:
Computer code for using the illumination source control signal to modify an operation of the illumination source.

21. The computer readable medium as recited in claim 20, wherein the operation modified by the illumination source control signal is a duty cycle of a power supply used to provide power to the illumination source.

22. Non-transitory computer readable medium executable by a processor for generating an alignment factor comprises:
during an ambient light sensor calibration operation,
(a) providing an ambient light sensor calibration setup in a calibration enclosure, the ambient light sensor calibration setup including at least a Lambertian responsive light sensor, a light source arranged to provide an adjustable light level and an adjustable orientation in relation to the ambient light sensor;
(b) adjusting a brightness level of the ambient light of the calibration enclosure;
(c) changing an orientation of the ambient light sensor relative to the light source;
(c) reading data from a light meter in accordance with light detected by the light sensor;
(d) setting a target luminance of the light source to a pre-determined value;
(e) forwarding a corrected light meter reading to a processor;
(f) computing calibration factor CF by a system processor based upon the corrected light meter reading and an initial alignment factor AFᵢₙₜ; and
(g) storing the calibration factor CF in a memory device.

23. The computer readable medium as recited in claim 22, wherein the enclosure ambient brightness level is a typical user brightness level LM_{typical}.

24. The computer readable medium as recited in claim 23, wherein the pre-determined value of the target luminance is based upon a Lambertian response and the user brightness level LMᵤₛₑᵣ.

25. The computer readable medium as recited in claim 24, wherein the corrected light meter reading is based upon a target brightness level LM_{target} and the initial alignment factor AFᵢₙₜ.

26. The computer readable medium as recited in claim 25, further comprising:
reading data LM_{system} from the light sensor;
if the data LM_{system} is different from user brightness level LM_{typical}, then
calculating a updated alignment factor AF_{new}, otherwise,
storing the alignment factor AF in a process computer's code.

27. The computer readable medium as recited in claim 26, wherein repeating (b) through (g) until the data LM_{system} is about equal to user brightness level LM_{typical}.
